(19) United States
(12) Patent Application Publication
(10) Pub. No.: US 2011/0075914 A1
(43) Pub. Date: Mar. 31, 2011

(54) SYSTEM AND METHOD FOR THE QUANTITATIVE ASSESSMENT OF DIGITAL HISTOLOGY IMAGES

(75) Inventors: Robert John Filkins, Niskayuna, NY (US); Kevin Kenny, Niskayuna, NY (US); David Henderson, Clifton Park, NY (US); Jens Rittscher, Ballston Lake, NY (US)

(73) Assignee: GENERAL ELECTRIC COMPANY, Schenectady, NY (US)

(21) Appl. No.: 12/571,158

(22) Filed: Sep. 30, 2009

(51) Int. Cl. G06K 9/00

(52) U.S. Cl. 382/133

(57) ABSTRACT

The present disclosure concerns a method and system for assessing image quality of sub-images used to form a composite image using an algorithm developed by applying statistical correlation techniques to historical data on features of sub-images which were manually evaluated by experts and using those assessment to make decisions about the further processing of the sub-images which are being assessed. The method and system find particular value in the processing of sub-images generated while there is relative motion between the specimen under examination and the objective lens of a microscope such as when the microscope stage follows a planned traverse in the focal plane and a digital image is created at intervals correlated to the motion of the stage so that a region of interest in the specimen under examination is covered by the sub-images. The further processing decisions include manually examining the sub-images assessed to have unacceptable image quality, reimaging the entire region of interest and recreating specific sub-images. The method and system may also involve overlaying portions of a composite image with an indication that they were drawn from sub-images of unacceptable image quality.

### BACKGROUND

This invention relates generally to the fast and efficient assessment of the quality of sub-images of a histology specimen and the use of those assessments to govern the creation of a composite image of said specimen. Histology specimens are typically examined under magnification which means that the field of view is rather limited and so each digital sub-image of a given field of view covers only a small portion of the region of interest.

One way of dealing with such limited view sub-images is to assemble them into one composite image that covers a reasonable region of the specimen for pathological examination. This usually involves creating a digital sub-image for each field of view under the microscope in some regular manner and then creating a composite image from these sub-images. This can be done by relative motion between the specimen and the objective lens of the microscope with the creation of sub-images which are either adjacent to each other or overlap with each other. One approach is to continuously move a microscope stage while having a computer routine trigger the creation of sub-images at appropriate times so that a mosaic is created blanketing the entire region of interest.

The quality of each of these sub-images is a matter of concern. In order to obtain practical processing times these individual sub-images are created quickly in an automated procedure. But this can result in some sub-images being of unacceptable quality for a number of reasons with one common one being that the sub-image is out of focus. Defects in the specimen such as tissue folding can also be a source of unacceptable sub-image quality.

One approach to the out of focus concern is outlined in U.S. Published Patent Application 2008/0266440. A number of lower quality images are quickly taken and a quantitative measure of the focus of each image, such as a Brenner Gradient, is taken of each image and the results are supplied to an algorithm that then directs the capture of a primary image at an optimized focal distance. While this approach has yielded useful results further improvements are possible.

### BRIEF DESCRIPTION

The present invention involves using multiple quantitative measures of image quality to assess the quality of sub-images of a histological specimen and using those measures to govern assembling these sub-images into a composite image. In one embodiment a histology specimen is examined under magnification and a digital image is made of each field of view under a microscope in a regular manner until the entire region of interest is covered by these sub-images. A number of patterns for blanketing this region may be convenient including a serpentine scan and a raster scan. The quality of each of these sub-images is evaluated using multiple quantitative measures of image characteristics. These measures are typically statistical and are combined in an algorithm that provides a value that may be evaluated against certain threshold values to decide upon further action. In some cases no sub-images of unacceptable quality are found which cover features of pathological interest. In other cases a limited enough number of sub-images of unacceptable quality are found to justify recreating just those sub-images with a procedure that assures better image quality. In yet other cases the number of sub-images of unacceptable quality is such that reimaging the entire specimen is justified.

In one embodiment the specimen is placed on a microscope stage that is then continuously moved in a regular manner such that the entire region of interest is covered and a digital camera coupled with a microscope is activated to create sub-images of adjoining or overlapping fields of view such that the entire region of interest is blanketed. It is convenient to continuously or at short time intervals sense the position of the microscope stage and to use this information to trigger said digital camera.

In one embodiment the algorithm for assessing sub-image quality is created from a historical study of a set of digital images of histological specimens. One approach is to have a set of digital images manually graded and then to measure a number of quantitative features of these images and correlate the values of these features to the grading of the image.

In one embodiment the focus for the initial sub-images is not optimized in order to minimize processing time and the focus is more optimized for any sub-images that are generated to replace any sub-images of unacceptable image quality.

In one embodiment a composite image is created in which the sub-images of unacceptable image quality are indicated, for instance by a color overlay. This allows a fast and efficient examination of the composite image to determine if any portion of the composite image covering a feature of interest has compromised image quality.

### DETAILED DESCRIPTION

According to the present invention a tissue specimen is subjected to a microscopic examination, typically at a magnification between 10 and 40×, and a series of digital sub-images is created which covers a region of interest in the specimen. Each sub-image covers all or a defined portion of the field of view of the microscope and the series is designed such that these individual sub-images can be assembled to create a digital image of the entire region of interest. One convenient approach is to have each individual sub-image adjoin or overlap with the immediately previous image. Typically this results in the generation of about 268 sub-images at 20× and 1072 sub-images at 40×.

The digital sub-images are created automatically using a routine that causes relative motion between the objective lens of the microscope and the specimen in the focal plane of the microscope. One convenient approach is to have a continuously moving microscope stage and a digital camera integrated with the microscope that acquires images at appropriate time intervals. Another approach is to have a control mechanism that moves the microscope stage a defined distance and then causes a digital camera integrated with the microscope to acquire an image of the field of view of the microscope after each movement.

The individual sub-images are typically created quickly without a thorough examination of the quality of the sub-image at the time it is created. There is typically an auto focusing routine associated with the acquisition of these sub-images that in the interests of expediency does not necessarily result in a precise focus. It has been found to be more efficient to rely on post acquisition evaluations of the sub-images.

The image quality of each sub-image is evaluated post acquisition using an algorithm that relates overall image quality to various image features that can be automatically evaluated to yield a numerical value for each feature. Typically these numerical values are the result of statistical treatments of raw data obtained by an automated examination of the sub-images. For instance one can calculate the mean, variance, skew and kurtosis of the image local contrast.

The algorithm is conveniently developed by gathering feature data from a number of sub-images and having the quality of the same sub-images manually evaluated by skilled observers. Then a correlation is developed between the numerical feature data and the manual quality evaluation. One convenient correlation technique is the use of a machine learning meta-algorithm such as Adaboast. Another approach is to establish a correlation using a neural network. In developing such an algorithm it is typical to use a training set of data in which the numerical sub-image features and the evaluation of each sub-image or group of sub-images are input. Then the algorithm so developed can be applied to the numerical feature data for another set of sub-images to determine just how well the algorithm predicts the evaluations of these sub-images.

The features that are used to construct the algorithm may be any of those that have been proposed for the evaluation of image quality. One convenient source is Y. SUN, S. DUTHALER, and B. J. NELSON, “Autofocusing in Computer Microscopy: Selecting the Optimal Focus Algorithm”, MICROSCOPY RESEARCH AND TECHNIQUE 65:139-149, 2004, incorporated herein by reference. This article contains a compilation of 18 features that can be developed from measurements that can be made on digital images. It is advantageous to use a large number of features because the correlation statistics will indicate which have a significant impact on image quality allowing those that have no or minimal impact to be eliminated from the image quality algorithm. On the other hand so long as there is no adverse impact on computing time there is no harm to retaining such features in the algorithm. And if the correlation statistics are ever rerun on a larger data set such features may become more significant and aid in developing a more precise algorithm.

One approach is to manually evaluate a group of adjoining sub-images and assign the evaluation to each sub-image in the group. The evaluation and numerical feature data is then used to create and test an algorithm just as if each sub-image had been individually evaluated.

Once an algorithm has been developed and validated against a manual expert evaluation of image quality it can be used to govern the further processing of the sub-images being used to construct a composite digital image. For instance once a full set of sub-images has been created the algorithm can be applied to them to flag those that have unacceptable image quality. If the number of sub-images that have unacceptable image quality exceeds a selected threshold, for example 5% of the total number or about 14 at 20×, the region can be marked for special treatment such as manual evaluation or reimaging. Such a manual evaluation may reveal that the sub-images of unacceptable image quality do not cover any feature in the covered region of interest that is of pathological interest in which case the construction of the composite digital image may proceed. The reimaging may be done using a protocol that is less efficient but ensures greater consistency in image quality. For instance for a region of interest in which a number of sub-images are out of focus due to causes other than specimen topology the reimaging could use a protocol in which the microscope stage is stationary during the creation of each sub-image. On the other hand, topology issues might be cared for by taking multiple images at a given location using different distances between the objective lens of the microscope and the specimen under examination.

If the number of sub-images that have unacceptable image quality according to the algorithm is at or below a selected threshold just those sub-images can be flagged for reimaging. The reimaging may be done with a protocol that is less efficient but ensures greater image quality. For instance, the reimaging could be done with the microscope stage stationary rather than in motion or a more involved focusing protocol could be invoked such as one involving taking multiple images using different distances between the objective lens of the microscope and the specimen under examination.

Once all the sub-images have acceptable image quality they are assembled into a composite digital image that covers the region of interest.

Alternatively a composite digital image may be created with a certain minimal number of sub-images having unacceptable image quality. Those portions of the composite digital image based upon these sub-par sub-images may then be flagged perhaps by a color overlay. The composite digital image can then be inspected to determine if the flagged portions significantly compromise an examination of the region of interest. For instance, it may be determined that they do not impact upon any pathological features of interest in the region of interest.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A process for creating a composite digital image of multiple microscopy views of a tissue specimen by
a. creating digital images of portions of the desired composite image in a regular pattern such that the desired composite image is encompassed;
b. evaluating the image quality of each of these smaller images using statistical measures of image quality;
c. determining how many portions have unacceptable image quality;
d. deciding if the proportion of unacceptable image quality portions is so great that the quality of the entire set of portion digital images is unacceptable;
e. deciding if digital images of selected portions should be recreated to enhance their quality and creating such replacement images; and
f. if the overall image quality of the entire set of portion digital images is acceptable assembling the portions into a single image.

2. The process of claim 1 wherein the portion digital images are created by continuously moving a microscope stage in a regular manner and taking digital images at regular intervals.

3. The process of claim 1 wherein the statistical measures were created from a historical study of various properties of digital tissue images and a correlation of the values of these properties to image quality.

4. The process of claim 1 in which the focusing for the initial portion digital images is not optimized in order to increase processing time.

5. The process of claim 4 wherein at least one portion digital image is recreated and the recreation uses a more optimized focus than the creation of the original portion digital image.

6. The process of claim 1 wherein the assembled digital image is marked to indicate which portion digital images had unacceptable image quality.

7. The process of claim 1 wherein the evaluation of the quality of the entire set of portion digital images is made by assembling the portions into a single image and marking those portion images which have unacceptable image quality.
